(19) United States
(12) Patent Application Publication
(10) Pub. No.: US 2009/0320702 A1
(43) Pub. Date: Dec. 31, 2009

(54) INK DOSING DEVICE OF A PRINTING GROUP, AND METHOD FOR CONTROLLING THE INK DOSING DEVICE

(76) Inventor: Detlef Alfons Büchner, Dorfprozelten (DE)

Correspondence Address: JONES, TULLAR & COOPER, P.C., P.O. BOX 2266 EADS STATION, ARLINGTON, VA, 22202, US

(21) Appl. No.: 12/310,405

(22) PCT Filed: Aug. 9, 2007
(86) PCT No.: PCT/EP2007/058253

§ 371 Date: Feb. 24, 2009

(30) Foreign Application Priority Data
Sep. 6, 2006 (DE) 10 2006 041 881.6

(51) Int. Cl. B41F 31/02

(52) U.S. Cl. 101/365

(57) ABSTRACT

An ink dosing device of a printing group, that includes a printing group cylinder which is configured as a plate cylinder, includes an inking unit. The ink dosing device has a number of physical zones which are arranged next to each other in a longitudinal direction. These physical zones can be individually adjusted by the use of dosing elements in order to individually adjust, section by section, the amount of ink that is applied. A control station is provided with a number of operator elements which are assigned to virtual zones of a printed page. These operator elements are usable to trigger the dosing elements. The segmentation of the virtual zones of the ink dosing device, in relation to the width of a printed page, differs in number and/or position of the zones of the ink dosing device across the width of the printed page from the segmentation of the zones in the control station in relation to the width of the printed page with respect to the number and/or position of the zones in the control station across the width of a printed page. At least two dosing elements are allocated using computing technology to at least one of the operator elements with respect to the relevance of the latter for the adjustment process following the selection of the operator element.

### CROSS-REFERENCE TO RELATED APPLICATIONS

This application is the U.S. national phase, under 35 U.S.C. 371, of PCT/EP 2007/058253, filed Aug. 9, 2007; published as WO 2008/028744 A1 on Mar. 13, 2008 and claiming priority to DE 10 2006 041 881.6, filed Sep. 6, 2006, the disclosures of which are expressly incorporated herein by reference.

### FIELD OF THE INVENTION

The present invention is directed to an ink metering device of a printing couple and to a method of controlling the ink metering device. The ink metering device has a number of physical zones that are arranged side by side in the longitudinal direction of the printing couple cylinders. These zones can be adjusted separately using metering elements for each zones.

### BACKGROUND OF THE INVENTION

A control device for controlling the printing of webs of material is known from DE 198 56 675 A1. An analysis table, with a group of keys for individually controlling the opening and closing of ink duct screws, is provided. The spacing of the keys from one another corresponds to the physical spacing of the respective ink duct screws.

A control element, which is situated beneath a sheet of paper that has been inspected by the press operator, and which is brought into a position that corresponds to a strip of the printed image that is to be corrected is disclosed in DE 42 16 440 B4. An automatic recognition system adjusts the relevant ink key for this zone and also for adjacent zones.

DE 10 2004 018 743 A1 discloses a device for visualizing ink metering element settings using a number of display devices. The number of display devices corresponds to the number of ink metering elements.

An ink metering device is known from DE 10 2004 022 700 B3. A panoramic ink zone, which is located between two single pages, is assigned on a display screen to both a display bar for one printed page and to a display bar for the other printed page. To prevent a contradictory adjustment via one and the same control element, a mean value for the two values that are desired by the press operator is determined. The mean value is taken into account by the shared control element.

DE 10 2004 054 599 A1 discloses a forme cylinder of a printing press. The forme cylinder supports a plurality of printing formes side by side in the axial direction.

### SUMMARY OF THE INVENTION

The object of the present invention is to provide an ink metering device of a printing couple and a method of controlling such an ink metering device so as to allow standardization for different machine widths.

The object is attained in accordance with the present invention by the provision of an ink metering device of a printing couple including a forme cylinder and an inking unit. The ink metering device has a number of physical zones which are arranged longitudinally side by side in the direction of the forme cylinder. Each of these physical zones can be adjusted individually using metering elements. These metering elements control the quantity of ink to be applied in each physical zone. A control station is provided with a number of operator elements which are assigned to virtual zones of a printed page and which are usable for controlling the metering elements.

The benefits to be achieved in accordance with the present invention consist particularly in that a cost-effective and standardizable solution for inking units in newspaper printing presses is devised. The previous high cost of the customary small series production of each ink fountain and the corresponding metering elements specific to the widest variety of press and/or product formats can be decreased substantially, at least over broad areas or for series of related printing formats.

By adjusting the offsets, which arise as a result of the standardized metering elements, to the technical operating conditions using algorithmic calculations, and particularly by using a computer-supported software solution, operation can be carried out in the customary manner without significant cost to the printer.

### BRIEF DESCRIPTION OF THE DRAWINGS

Preferred embodiments of the present invention are represented in the set of drawings and will be specified in greater detail in what follows.

The drawings show in

FIG. 1 a schematic representation of a printing couple and a control station for a first machine width; in

FIG. 2 a schematic representation of a printing couple for a second machine width, with an inking unit having a lower zonal segmentation in relation to the control station; and in

FIG. 3 a schematic representation of a printing couple with an inking unit having a higher zonal segmentation in relation to the control station.

### DESCRIPTION OF THE PREFERRED EMBODIMENTS

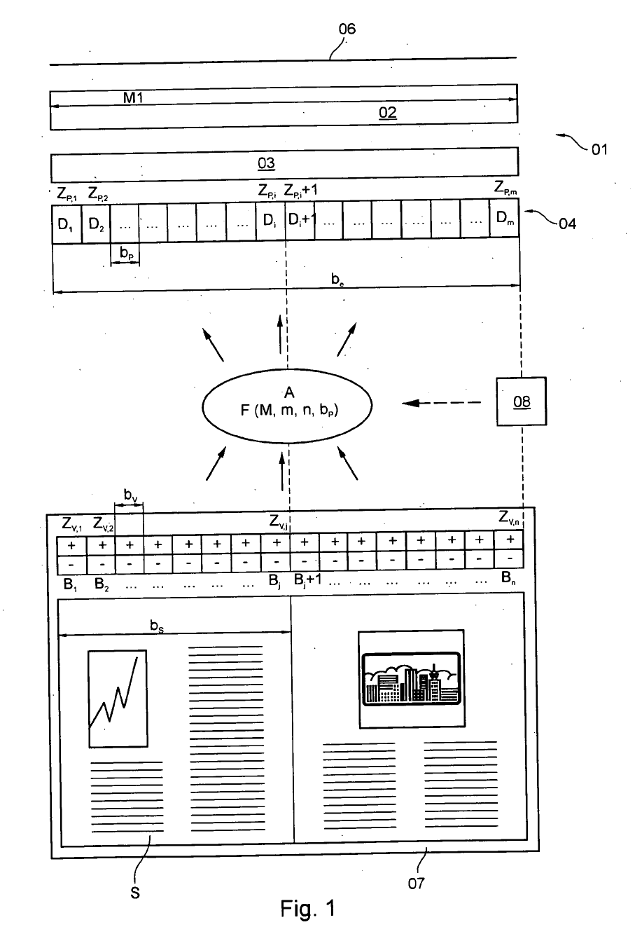

A printing couple 01 of a printing press is indicated only schematically in FIG. 1. This printing couple 01 may preferably be a newspaper printing couple 01 of a newspaper printing press. Printing couple 01 has at least one printing couple cylinder 02, such as for example, a forme cylinder 02, and also has an inking unit for use in inking the forme cylinder 02. The inking unit has at least one ink roller 03 and an ink metering device 04, which ink metering device 04 works in cooperation with the ink roller 03 to achieve inking of the forme cylinder 02. A print substrate 06, especially a paper web 06, can be printed by the printing couple 01. The printing couple 01 is preferably embodied as an offset printing couple for newspaper printing, and has a transfer cylinder, which is not specifically shown, and which is situated between the forme cylinder 02 and the paper web 06. In newspaper printing, as opposed to in high-quality commercial or sheet offset printing, uncoated or only lightly coated paper, such as, for example, with a coating weight of up to 20 g/m², and especially with a coating weight of up to a maximum of 10 g/m², is printed as the print substrate. Depending upon the type of inking unit, which is being used one or more additional rollers can be arranged between ink roller 03 and forme cylinder 02. The inking roller 03 can be provided as an ink fountain roller of a film inking unit, as an ink fountain roller of an ink pumping system or as an anilox roller of an anilox or short inking system. The forme cylinder 02 has a plurality of removable printing formes, which are not specifically shown, such as, for example two, four or six, printing formes depending upon the web width, arranged on its outer periphery. These printing formes can be arranged for example, side by side in the axial or longitudinal direction of the forme cylinder 02.

A machine width M1, and specifically an effective width of the printing couple cylinder 02, is usually adjusted to the maximum width of the print substrate or of the web of material to be printed. In newspaper printing, this machine width corresponds, for example, substantially to somewhat more than a whole number multiple of the width of one newspaper page of the desired maximum product format, or to the width of all of the printing formes that can be arranged side by side on the forme cylinder 02. Press manufacturers therefore design and supply newspaper printing presses of different machine widths for use by different publishing houses or for use by the print shops that serve them.

The print images to be applied to the print substrate 06 ordinarily require an amount of ink that varies across the width of the print image. This ink amount varies, based upon the print image, in order to achieve the desired ink density and thereby the desired inking across the width of the print image.

To ensure proper individual ink zone inking, over the entire printing width, the ink metering device 04 has a plurality of individually adjustable metering elements Dᵢ (i=1 . . . m; with mε [symbol] ), side by side in an axial direction, with which plurality of individual adjustable metering elements Dᵢ the supply of ink can be controlled in each corresponding zone Z_{P,i} (i=1 . . . m; with mε [symbol] ); index wherein P is used for identification of “physical” zones. The ink metering device 04, having a plurality of adjustable zones Z_{P,i} can be configured in a variety of ways. In the several drawing figures, the ink metering device 04 is embodied with a plurality of metering elements Dᵢ which are configured as so-called ink blades Dᵢ, or scraping elements, which ink blades D can be adjusted individually, in terms of their distance from the circumferential surface of the roller 03, via drives, which are not shown here. Based upon the gap width of this distance, the scraping by the ink blades Dᵢ leaves a thicker or a thinner film of ink on the circumferential surface of the inking roller 03, which has been placed in contact beforehand with an ink reservoir. In order to successfully ensure individual inking over the printing width or over the width of the ink fountain 04, the gap between inking roller 03 and metering element Dᵢ is adjusted by zone Z_{P,i}, for example, by using the drives, which are not shown here, for the individual metering elements Dᵢ.

In an embodiment of the present invention, which is not specifically illustrated here, a plurality of pumps Dᵢ or a plurality of outlet openings Dᵢ, each of which is provided with valves that are controllable with respect to flow and which are arranged in the flow path, can also be provided for use as the metering elements Dᵢ. The ink metering device 04 and the method for controlling the ink metering device 04 will be described, by way of example, within the context of a so-called ink fountain 04 having an ink reservoir, such as an ink trough, and including the plurality of ink blades Dᵢ. The principle which will be described in relation to the ink blades Dᵢ can also be applied to every other embodiment of metering elements Dᵢ that form physical zones Z_{P,i}.

In newspaper printing such as, for example, in inking units of newspaper printing presses, different machine widths M1; M2 are offered for different maximum product formats. Ordinarily, however, inking units, that are adapted specifically to these respective machine widths M1; M2, are used for these different machine widths M1; M2. The segmentation of the physical zones Z_{P,i}, which is based upon a width bₛ or a page width bₛ of one printed page S, is always chosen as a whole number wherein, for example, the number for Zₚ may equal 8. Thus, for example, for a newspaper printing press having a wider product format, an inking unit having a specific number of wider metering elements Dᵢ or zones Z_{P,i} such as, for example, having eight such zones, has heretofore been used. For a newspaper printing press having a narrower product format, an inking unit having the same number, such as, for example, eight zones or having a different whole number of metering elements Dᵢ or zones Z_{P,i}, each having a smaller physical zone width bₚ, has been used. Overall, an even number of zones Z_{P,m} corresponds to the width of the printed page. The number of adjustable physical zones Z_{P,i} is ordinarily reflected in the number of operator elements Bⱼ (j=1 . . . n, with nε [symbol] ) with the corresponding virtual zones Z_{V,j} (j=1 . . . n, with nε [symbol] ) on a control station 07. In FIG. 1, for each printed page S to be placed on the control station 07, a number, such as, for example, a virtual zone number Zᵥ equal to 8, of operator elements Bⱼ, or of pairs of operator elements, each characterized by + and −, and being embodied as push buttons, for example, are provided. With the use of these operator elements B, the press operator can control the metering elements Dᵢ and thereby can control the gaps to the physical zones Z_{P,i}. By pressing “+”, for example, the flow of ink is increased, through an enlargement of gap width or through an increase in pump power, and by pressing “−”, for example, the flow of ink is decreased, through a reduction of gap width or through a decrease in pump power. In this connection, as depicted in FIG. 1, the numerical and the spatial segmentation of the virtual zones Z_{V,j} on the control station 07, as also depicted in FIG. 1, corresponds to the numerical and to the spatial segmentation of the physical zones Z_{P,i} on the inking unit. If a presetting system 08 is provided, the required area coverages or ink densities can also be converted to the positioning of this whole number of metering elements Dᵢ or zones Z_{P,i} from product definition in the production stage, through the pre-printing stage, up to the presetting system 08. In FIG. 1, a double-sided newspaper page, with each page having a page width b_{S} and the allocated operator elements Bⱼ and/or virtual zones Z_{V,j}, with the virtual zone widths b_{V}, is represented schematically in the lower portion of the diagram. In this case, the virtual zone widths b_{V} that apply to the pages placed on the platform correspond to the physical zone widths b_{P} on the inking unit. The number of virtual zones Z_{V,j} per printed page S corresponds to the number of active physical zones Z_{P,i}. An active, effective width bₑ of the ink metering device 04, such as, for example, the area with metering elements Dᵢ, which is required for the present machine width M1; M2, corresponds substantially to the machine width M1; M2 or to the maximum web width.

In the typical configuration of the ink metering device 04 as being specific to a particular machine width, it is a disadvantage that especially the metering elements Dᵢ, have a high structural design costs. The usual disadvantages, that are known for very small series production, apply.

The method and apparatus of the ink metering device, as will be described in what follows, is based upon the concept of eliminating the requirement of specifically configured ink metering devices 04, and especially on the elimination of the metering elements Dᵢ, for each specific machine width M1; M2 of a printing press 01 used in newspaper printing. Instead, in accordance with the present invention, the method and apparatus is directed to using at least the same metering elements Dᵢ, and advantageously even the same ink metering devices 04, at least within certain limits, for various different machine widths M1; M2.

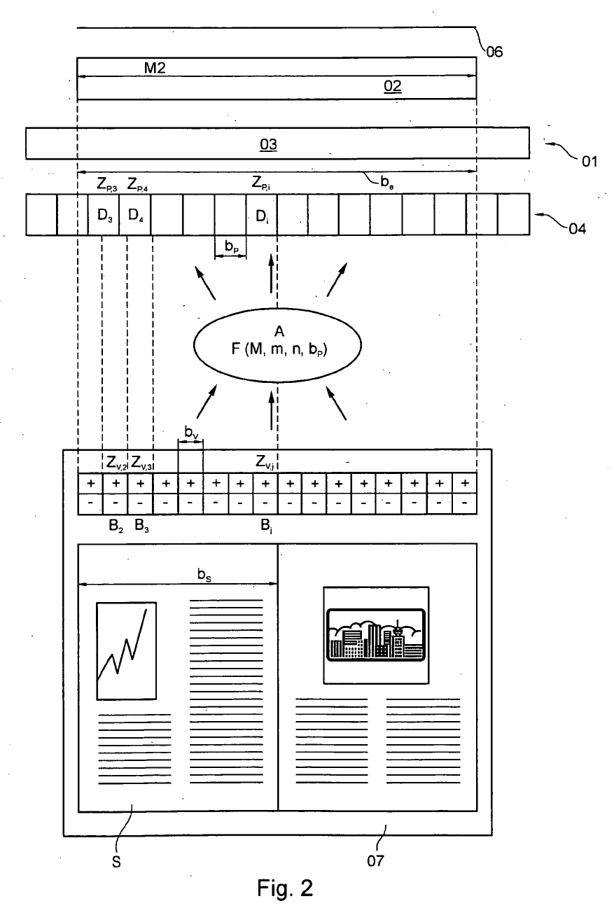

In FIG. 2, there is depicted a printing couple 01 and a control station 07, which are illustrated schematically, and which are provided having a smaller product format and a narrower machine width M2 than the press which was depicted in FIG. 1. In this printing couple, a plurality of printing formes, which are narrower than those associated with the press of FIG. 1, are arranged side by side on the forme cylinder 02, for example. The support surface on the control station 07 and the width of the group of operator elements Bⱼ or the totality of the virtual zones Z_{V,j} is also smaller or narrower in configuration, corresponding to the product to be printed. In FIG. 2, an ink fountain 04, which was structured, for example, for use with a machine width M1 from FIG. 1, is shown. The number of virtual zones Z_{V,j} on the control station 07 that are relevant to the printed pages S is the same, for example, as was the number of such virtual zones Zᵥⱼ for the press from FIG. 1, but each of the virtual zones Z_{V,j} have a narrower zone width b_{V} in FIG. 2. However, the ink fountain 04 has metering elements Dᵢ or has physical zones Z_{P,i}. The zone width b_{P} of the physical zones Z_{P,i} or of the metering elements Dᵢ is now different from the zone width b_{V} of the virtual zones Z_{V,j} of FIG. 2. In this case, it is larger. The virtual segmentation of the zones Z_{V,j}, on the control station 07 or at the pre-print stage, which is based upon the printed page width, or the machine width M1; M2, is different from the physical segmentation of the zones Z_{P,i} on the ink metering device 04, which is based upon the printed page width, or on the machine width M1; M2. Whereas the virtual segmentation is always a whole number, a virtual segmentation that is based upon the printed page width or effective width bₑ can also deviate from a whole number. For example, in FIG. 2 this virtual segmentation can be approximately 6.3 per printed page S. In this case, segmentation is understood as the quotient of the number of side by side printed pages S taken into consideration and the number of allocated zones Z_{V,j}, Z_{P,i} projected across this width b_{S}. For example, in FIG. 2: virtual segmentation 8/1 or 16/2, etc., and physical segmentation 6.3/1 or 12.6/2, etc. The segmentations of the physical and virtual zones Z_{P,i}, Z_{V,j} can also differ in terms of spatial positioning, based upon the printed page S. In the present case, the differences consist in segmentation with respect to the number and the positioning of the zones Z_{P,i}, Z_{V,j}.

If the press operator were to perform an adjustment, using the operator element B₃ for its virtual zone Z_{V,3}, for example, and thereby actuating the drive of the metering element D₃, as is customary in newspaper printing, and without taking into account the different zone widths bₚ; b_{V} and/or the different zone positions, this would be incorrect, as may be seen in FIG. 2. To allow inking units having the same physical zone width bₚ to be used for different machine widths M1; M2, an algorithmic calculation A, which will be referred to here as an algorithm, is provided, which algorithm takes into account the differences between the virtual and physical zones Z_{V,j}, Z_{P,i} in terms of number and/or position and/or width, and converts these appropriately.

As is shown in FIG. 2, the inking unit or the metering device 04 can have more than the number of metering elements Dᵢ that are absolutely necessary, or can have only as many metering elements Dₘ as are required to fully cover the effective width bₑ, such as, for example, the present machine width M2. In the configuration of FIG. 2, seven metering elements Dᵢ are required per margin side, because six are insufficient. In the first case, the same metering device 04 can be used for different machine widths M1; M2, and in the second case at least the same metering elements Dᵢ can be used for different widths of the metering device 04.

If, in the example depicted in FIG. 2, the print operator uses the operator element B₃ to adjust the virtual zone Z_{V,3} assigned to a printed page strip, for example, the algorithm A is then used to perform a conversion, so that the drive of the metering element D₄ is actuated. Advantageously, the magnitude of the coverage or of the overlap between the position and the width of the virtual and physical zones Z_{V,3} and Z_{P,4} is taken into account with respect to the magnitude of the actuation signal. Because, in this case, the physical zone Z_{P,4} is wider than the allocated virtual zone Z_{V,3}, the required actual change in the gap width is smaller than the virtually required change. If, as shown in FIG. 2, the virtual zone Z_{V,2} affects a plurality of the physical zones Z_{P,i}, in this case affecting Z_{P,4} and Z_{P,3}, a suitable conversion is performed such that a plurality of metering elements Dᵢ, in this case D₄ and D₃, are correspondingly positioned, or their drives are correspondingly actuated, advantageously taking their coverage into account. The same conversion principle provides the basis for the, or for an algorithm for a presetting system 08, or for the prepress stage, if the preset values for the physical zones Z_{P,i} are to be determined from the otherwise customary standardized, whole number coordinated zones. It is advantageous, however, if, in the presetting system 08 or in the prepress stage, the actually implemented physical zones Z_{P,i} are already accounted for in the calculation of the preset values from the required area coverages or ink densities, and are stored there in the corresponding programs.

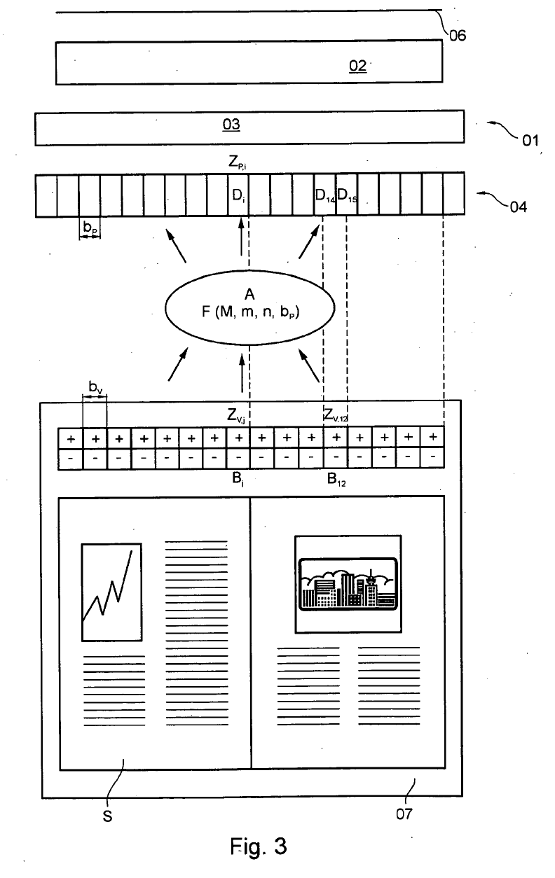

In another preferred embodiment of the principle of the present invention, as described in connection with FIG. 1 and FIG. 2, in FIG. 3 another embodiment of a metering device 04 is shown. In this embodiment, the width bₚ of each of the physical zones Z_{P,i} is narrower than is the width b_{V} of the corresponding virtual zones Z_{V,j} on the control station 07 or in the standard settings of the presetting system. What has been described above, in reference to FIGS. 1 and 2, is similarly applicable in the embodiment of FIG. 3. The virtual and the physical or the effective segmentation of the zones Z_{V,j}, Z_{P,i} are again different from one another. The algorithm A again ensures that when a specific virtual zone Z_{V,j} is selected, a corresponding transfer to the relevant metering element Dᵢ or to the corresponding metering elements Dᵢ, or to their drive or drives occurs. Here, the physical segmentation is in whole numbers, in this case nine, by way of example. However it could also differ from a whole number, based upon the printed page width or on the effective width bₑ of the ink metering device 04. The virtual segmentation, or the number of zones Z_{V,j} or operator elements Bⱼ per printed page S, is a whole number and, in this case, is eight.

In the embodiment which is depicted in FIG. 3, if the press operator wishes to use the operator element B₁₂ to modify the virtual zone Z_{v,12} which is allocated to a printed page strip, for example, the algorithm A will perform a conversion such that the drives for the metering element D₁₄ and for the metering element D₁₅ are both actuated. The magnitude of the respectively necessary changes to the gap can then again take into account the degree of coverage or overlap between the relative position and width b_{V}; bₚ of the relevant virtual and physical zones Z_{V,j}, Z_{P,i}.

In general, the ink metering device 04 has a number “m” of metering elements Dᵢ such that the total of the widths bₚ of the zones of the number “m” of metering elements Dᵢ is greater than, or is equal to the machine width M1; M2 or the maximum web width. The width of the ink metering device 04 is thus configured accordingly. If, as in the case of the examples or the embodiments of FIG. 2 and FIG. 3, metering elements Dᵢ are provided in margin areas of the ink metering device 04 which are outside of the effective width bₑ, then in the algorithm A, or in the press control or presetting, it can be provided that these margin area metering elements Dᵢ are generally adjusted to a closed gap. In an advantageous variation of the present invention in relation to FIG. 2 and to FIG. 3, it is provided that a varying total width of the ink metering device 04 is permitted, but only in stages of the same metering elements Dᵢ that are used for different machine widths M1; M2. In other words, the number “m” of metering elements Dᵢ in the ink metering device 04 is such that the total of the widths bₚ of the zones Z_{P,i} is greater than, or is equal to the machine width M1; M2. However, an (m+1)th metering element Dₘ₊₁ would lie completely outside of the effective width bₑ or would lie outside of the projection of the machine width M1; M2.

The control station 07 therefore continues to be embodied, as is customary, with a whole number, and advantageously with an even whole number, “n”, of virtual zones Z_{V,j} and/or with the corresponding number “m” of operator elements Bⱼ, such as, for example, “n” pairs of push buttons Bⱼ. The ink metering device 04 is configured with a different segmentation of zones Z_{P,i} of a standardized width b_{P} and optionally with a different number “m”. The offsets between virtual and physical zones Z_{V,j}, Z_{P,l}, which are dependent upon format and/or number of zones and/or zone width, are converted and are taken into account using the algorithm A, especially with computer support. Corresponding computing assemblies, containing the algorithm, are provided for this purpose. The algorithm A can be a function, among other things, of the machine width M1; M2 defined by the maximum web width and/or of the number “m” of physical zones Z_{P,i} or of metering elements Dₘ and/or of the number “n” of virtual zones Z_{V,j} or of operator elements Bⱼ and/or of a width b_{P} of the physical zones Z_{P,i}. The algorithm A contains fixed rules for the conversion or for the consideration of the offsets or of the difference in the number and/or the position of the zones Z_{V,j}; Z_{P,i}. These fixed rules and/or the aforementioned input parameters, such as machine width, “m”, “n”, and the like can be defined, but stored in the computing assembly so as to be modifiable by press operators.

In the presetting process, the preset values for the metering elements Dᵢ or for the area coverages can advantageously be based directly on the physical zone number “m” and on the physical zone width b_{P}. It is also possible, however, for the preset values or for the area coverage values to be based on the zone number “n” on the control station 07, converted there using the algorithm A to accommodate the physical conditions in the manner described above, and acted upon by those of the metering elements Dᵢ or their drives.

For all the examples or embodiments depicted in FIG. 2 and in FIG. 3, or the operating types, in which the segmentation of physical and virtual zones Z_{P,i}, Z_{V,j}, based upon the printed page width, differs, a plurality of metering elements Dᵢ, such as, for example, at least two metering elements, are assigned to at least one of the operator elements Bⱼ via the computing assembly or the algorithm which is implemented therein, or are relevant with respect to control. In turn, a plurality of operator elements Bⱼ, and especially two such operator elements Bⱼ, can be assigned to one of the plurality of metering elements Dᵢ, based upon overlap. The plurality of metering elements Dᵢ that are relevant to an operator element Bⱼ are preferably positioned taking into account the degree of their coverage in relation to the operator element Bⱼ.

For the aforementioned preferred embodiments of the present invention, which are illustrated in FIG. 2 and in FIG. 3, it is also characteristic not only for a metering element Dᵢ, which is situated between two printed pages S, to be assigned two operator elements Bⱼ of two adjacent printed pages S, but also for an adjustment to the overlap to be made for a plurality of operator elements Bⱼ and metering elements Dᵢ which are assigned to a printed page S, using the algorithm A. Therefore, based upon the printed page S, a plurality of zones are offset with respect to their position, or are different in terms of their number.

While preferred embodiments of an ink metering device of a printing couple and a method of controlling the ink metering device, in accordance with the present invention, have been set forth fully and completely hereinabove, it will be apparent to one of skill in the art that various changes in, for example, the drives for the cylinders, the specific ink being metered and the like could be made without departing from the true spirit and scope of the present invention which is accordingly to be limited only by the appended claims.

What is claimed is:

1-11. (canceled)

12. An ink metering device of a printing couple having a forme cylinder and an inking unit, said ink metering device comprising:
a number of physical zones of said ink metering device, said number of physical zones being arranged side by side in a longitudinal direction of said forme cylinder
a plurality of metering elements, each of said plurality of metering elements being adapted to adjust an individual associated one of said physical zones of said ink metering device to adjust a quantity of ink being applied by each said physical zone;
a control station;
a plurality of operator elements, each of said operator elements being assigned to a virtual zone of a printed page and usable to control said metering elements;
a number of virtual zones in said control station;
a physical segmentation of said number of physical zones of said ink metering device and based on a printed page width, with respect to one of said number and positions of said metering device across said printed page width;
a virtual segmentation of said number of virtual zones of said control elements based on said printed page width, with respect to one of said number and positions of said control zone, said virtual segmentation being different from said physical segmentation; and
computing means usable to assign at least two of said metering elements to at least one of said operating elements in response to a selection of said operator element.

13. The ink metering device of claim 12 wherein each of said physical zones has a first width and further wherein each of said virtual zones has a second width different from said first width.

14. The ink metering device of claim 12 further including a machine width defined by a maximum width of said printed page, and further including a total width of said number of physical zones, said total width of said physical zones being greater than said machine width.

15. The ink metering device of claim 12 wherein said number of physical zones is different from a whole number.

16. The ink metering device of claim 12 further including an algorithm in said computing means and adapted to account for differences between said segmentations of said physical zones and said virtual zones.

17. The ink metering device of claim 12 further including a signal path between said operator elements and drives for said metering elements, said computing means being located in said signal path.

18. The ink metering device of claim 12 further including a roller in said inking unit, said ink metering device cooperating with said roller.

19. The ink metering device of claim 12 further including a plurality of printing formes on said forme cylinder and arranged longitudinally side by side.

20. The ink metering device of claim 12 wherein said control station has a whole number of said virtual zones.

21. A method for controlling an ink metering device including;
providing a number of physical zones in said ink metering device;
providing an individually adjustable metering element for each one of said number of physical zones.
basing said number of physical zones on a printed page width;
providing a number of virtual zones, said number of virtual zones being based on said printed page width, said number of virtual zones being different from said number of physical zones;
providing an operator element for each of said virtual zones;
using said operators for controlling metering elements;
providing an algorithm calculation for controlling said metering elements taking into account differences in at least one of position and numbers between said virtual zones and said physical zones; and
using said algorithm for activating a plurality of said metering elements using at least one of said operator elements.

22. The method of claim 21 further including activating said plurality of metering elements and considering a coverage between associated ones of said physical zones and said virtual zones.
